(19) United States
(12) Patent Application Publication
(10) Pub. No.: US 2003/0156780 A1
(43) Pub. Date: Aug. 21, 2003

(54) Tunable filter

(75) Inventors: Moti Margalit, Zichron Yaaqov (IL); Elazar Cohen, Haifa (IL)

Correspondence Address: LADAS & PARRY, 26 WEST 61ST STREET, NEW YORK, NY, 10023, US

(73) Assignee: LAMBDA CROSSING, LTD.

(21) Appl. No.: 10/246,380

(22) Filed: Sep. 18, 2002

Related U.S. Application Data
(60) Provisional application No. 60/330,548, filed on Oct. 24, 2001.

(51) Int. Cl. G02B 6/26; G02B 6/27

(52) U.S. Cl. 385/15; 385/45; 385/39; 385/11

(57) ABSTRACT

A method is presented for controlling continuous propagation of input light through an optical device having an optical functional element of a controllably adjustable operation to affect light passing therethrough. The input light energy is distributed in a predetermined manner between first and second spatially separated paths, wherein the optical functional element is accommodated in the first path. The first and second paths are recombined downstream of the optical functional element with respect to a direction of light propagation through the device, to produce a light output of the optical device. This allows for directing substailly the entire energy of the input light through the second path, during adjustment of the operation of the functional optical element, and redirecting at least a predetermined portion of the input light to the first path to pass through the functional element, upon completion of the adjustment.

### FIELD OF THE INVENTION

This invention is generally in the field of optical devices and relates to a tunable optical device, particularly useful for adding or dropping channels in a wavelength division multiplexing optical communication system.

### BACKGROUND OF THE INVENTION

Optical transmission systems, which are based on wavelength division multiplexing (WDM, achieve high information capacities by aggregating many optical channels onto a signal strand of optical fiber. Tunable filters play a critical role in WDM communication systems. A tunable filter, which can redirect and route wavelengths is used in conjunction with tunable lasers to create a tunable transmitter, midway in the fiber in wavelength for add and drop multiplexing applications, and at the receiving end in conjunction with a broad band detector for a tunable receiver.

In applications of add and drop multiplexing, the tunable filter is often termed a three (or more) port device, with an input, express, and drop (add) ports. In these applications, the network traffic enters the device at the input, with most of the channels leaving at the express port. The dropped channels are redirected to the drop port, while the added channels are input from the add port. During all times, the network is operational, and in particular, when tuning the filter from one channel to another, a critical feature of the filter is termed “hitless tuning”, which is the ability to tune from one channel to another without disturbing (“hitting”) any of the express channels, since this would constitute a traffic disruption in the network.

Tunable filters in state of art implementations fall under the following two categories:

(1) Tunable filters based on spatial distribution of the different channels and switching of the channels to be dropped. Here, tunability is achieved by applying spatially distinct switches, which switch different channels to the drop port.

(2) Tunable filters based on a change in the frequency of operation by physical changes in the optical filter medium. These are the so-called “scanning” tunable filters”, since they scan over frequencies.

Hitless tuning can easily be achieved in the first implementation. However, the first implementation suffers from many other drawbacks, especially loss and cross talk, which render it unacceptable for optical networks. The second type filter is the preferred solution for optical networks.

U.S. Pat. No. 6,292,299 describes a hitless wavelength-tunable optical filter, which includes an add/drop region and a broadband optical reflector adjacent thereto. The operation of the filter is based on selectively repositioning an optical signal in the add/drop region while adding or dropping an optical wavelength channel, and on the use of a broadband optical reflector while tuning to a different optical wavelength channel.

The article “All fiber active add drop multiplexer”, IEEE Photonics Technology Letter, Vol. 9, No. 5 p 605 describes an architecture to be used as a reconfigurable router for exchanging channels between two fibers or as a reconfigurable add/drop multiplexing filter. The architecture consists of a Mach-Zender interferometer with identical gratings written in each arm, one pair of grating for each wavelength to be added or dropped. Each grating pair is also accompanied by a phase shifter, which is a thermo-optic heater.

### SUMMARY OF THE INVENTION

There is a need in the art to facilitate the hitless tuning of a functional optical element, controllably adjustable to appropriately affect light passing therethrough, by providing a novel optical method and device for continuously flowing light through the optical device of the kind having such a functional optical element. Such a functional optical element may be one of the following: a filter operable to add or drop a light beam to or from a light propagation channel; a gain element increasing the power of light passing therethrough, a variable optical attenuator increasing or reducing the power of light passing therethrough; a dispersive element changing the shape of a light signal passing therethrough; an interleave filter dropping some of the channels of the input light; and an equalization filter equalizing the energies of light in all the channels (e.g., different wavelength components of input light).

The present invention provides for selectively distributing in a predetermined manner the input light energy between spatially separated first and second paths, thereby enabling the selective passage of at least a predetermined portion of the input light through the functional element located in one of the two light-paths. This allows for directing substantially the entire light through the second path, during adjustment of the operation of the functional optical element, and redirecting at least a predetermined portion of the input light to the first path to pass through the functional element, upon completion of the adjustment. This technique permits the selective switching of light from one light-path to the other, without disturbing the flow of light from the input to the output of the optical device, thereby constructing a “hitless optical bypass switch”. Using such an optical device, internal functional elements, such as filters, amplifiers, and equalizers, can be switched in and out of the flow of traffic, without any adverse disturbance in the traffic.

There is thus provided according to one broad aspect of the present invention, a method for controlling the continuous propagation of input light through an optical device having an optical functional element of a controllably adjustable operation to affect light passing therethrough, the method comprising:

(i) distributing in a predetermined manner the input light energy between first and second spatially separated paths, said optical functional element being accommodated in the first path;

(ii) recombining the first and second paths downstream of the optical functional element with respect to a direction of light propagation through the device, to produce a light output of the optical device,

thereby allowing for directing substantially the entire energy of the input light through the second path, during adjustment of the operation of the functional optical element, and redirecting at least a predetermined portion of the input light to the first path to pass through the functional element, upon completion of the adjustment.

The input light energy distrbution between the first and second paths is achieved by passing the input light through an input vaiable coupler structure.

In one embodiment of the invention, the variable coupler structure is of the kind carrying multiple channels. The variable coupler mechanism of this kind can be realized using known approaches, such as Mach Zender Interferometers (MZI), variable Y junctions, mode converters, variable polarization rotator devices and a polarization splitter, switches, etc. In this case, the variable coupler selectively directs substantially the entire input light energy to one of the first and second paths.

In another embodiment of the invention, the variable coupler mechanism is frequency selective (a tunable frequency selective filter), and only a subset of the optical flow is involved, thereby reducing further still the adverse effect to traffic flow. In this case, the energy distribution between the first and second paths consists of the following: Variable frequency-selective coupling is applied to the multi-frequency input light, which is therefore split into first and second light components propagating through two spatially separated channels, respectively, the first light component comprising at least a portion of power of a selected frequency band, and the second light component comprising a remaining portion of the selected frequency band and all other frequency bands of the input light. A phase delay between the two channels is selectively created by adjusting the phase of the first light component. Then, depending on the phase of the first light component, either the first and second light components are combined to propagate through one output channel with substantially no power in the other output channel (dropping/adding channel), or all the power of the selected frequency band is directed through the dropping/adding output channel, while all other frequency components of the input light are directed through the other output channel.

Recombining the first and second paths may be implemented by an output variable coupler structure similar to the input one, namely, of the kind carrying multiple channels or the kind performing frequency selective coupling mechanism. The output variable coupler structure has two input ports associated with the first and second paths, respectively, and operates to produce the output light from light propagating through one of the first and second paths, or both of them. The input and output variable coupler structures may operate in conjunction with each other such that the same percentage of the input light redirected by the first variable coupler structure into each of the first and second paths is then recombined at the output of the second variable coupler. The constructive interference of light at the second (output) variable coupler is obtained by carefully controlling the phase matching between the first and second paths, i.e., output ports of the first (input) variable coupler.

The method of the present invention may include passing the input lift on its way to the input variable coupler, through a polarizing element. The polarizing element may be a polarization splitting element that splits the input light into two light components of different polarization directions. In this case, two polarization rotators are used, one accommodated in the path of one split light components, and the other accommodated in the respective one of said two paths. Alternatively, the polarizing element may be a controllable polarization rotator.

According to yet another aspect of the invention, there is provided an optical device comprising:

(a) an input variable coupler structure operable to receive input light and distribute in a predetermined manner the input light energy first and second spatially separated paths;

(b) an optical functional element accommodated in the first path, said functional element being of a controllable adjustable operation to affect light passing therethrough;

(c) a recombination element accommodated in said first and second paths downstream of the optical functional element with respect to a direction of light propagation through the device, said recombination element operating to produce a light output of the device from light coming from at least one of said first and second paths.

The input variable coupler structure, as well as the recombination element, may be a tunable frequency selective filter utilizing adjustment of the phase of light passing therethrough. In this case, the coupler structure is composed of a first tunable frequency-coupling element having one or two inputs and two outputs associated with two spatially separated optical channels, a phase adjusting element located in one of the outputs of the first element; and a second tunable frequency-coupling element (reciprocal of the first element). The functional element, which in this case affects only a specific frequency band, is located in one of the two outputs of the second element. Each of the first and second coupler elements operates to selectively transfer at least a portion of power of the selected frequency band of the input light to the optical path loaded with the phase adjusting element, while allowing propagation of the remaining portion of the input light through the other optical path.

The functional optical element to be used with the device of the present invention may be one of the following: a tunable channel dropping filter, piecewise dispersive element, piecewise gain element, channel equalization element, channel monitoring element, power sensor. The variable coupler may be one of the following: MZI, a mode transformation device, a variable Y coupler, a tunable frequency selective coupler, switch.

Preferably, the optical functional element is realized in the Planar Lightwave Circuits (PLC) technique. The PLC technique has an inherent advantage in integration of complex optical functions. The functional element may be based on micro ring resonators, or a closed-loop compound resonator disclosed in WO 01/27692 assigned to the assignee of the present application. Light paths are preferably realized using wavguides in which the refractive index of a core region, where light is guided, is higher than the refractive index of a cladding region. Light can be introduced into the device by coupling an optical fiber to the input waveguide of the device.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of the main elements of an optical device according to one embodiment of the invention;

FIG. 2 is a block diagram of another embodiment of the device according to the invention;

FIGS. 3 and 4 are block diagrams of two more embodiments of the invention; and

FIG. 5 illustrates the prior art GAC device suitable to be used in the optical device of FIG. 4

### DETAILED DESCRIPTION OF THE INVENTION

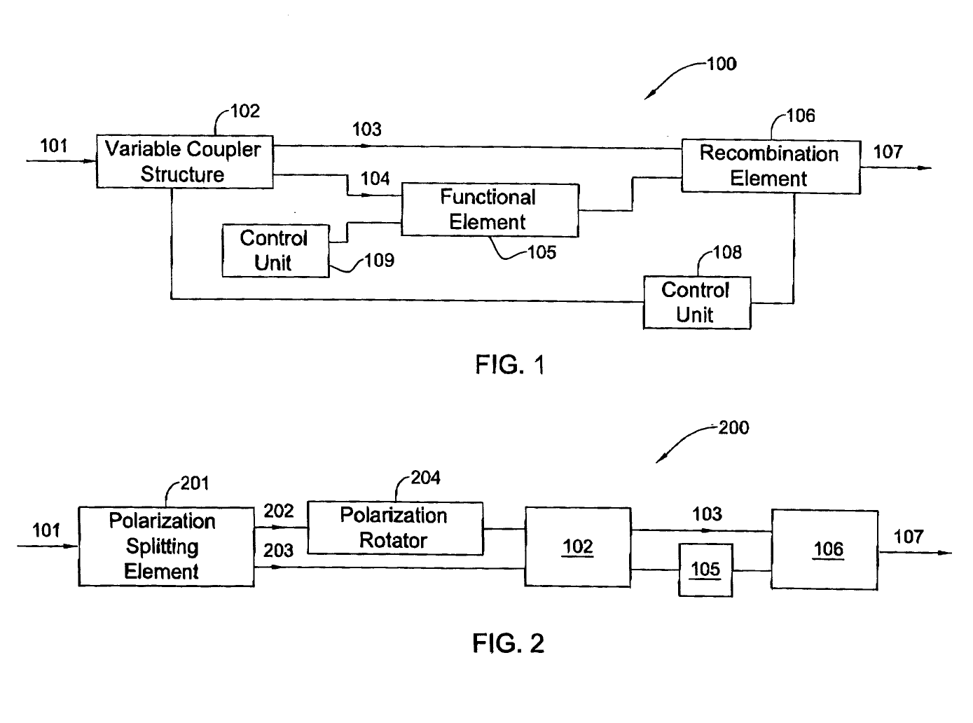

Referring to FIG. 1 there is illustrated an optical device, generally designed 100, constructed and operated according to the invention. The device 100 comprises a variable coupler 102, a functional element 105, and light recombination element 106. The coupler 102 has an input channel (arm) 101 for receiving an input light signal, and two output channels (arms) associated with two spatially separated light-paths (waveguides) 103 and 104. The functional element 105 is accommodated in one of the light paths 103 and 104—in the light-path 104 in the present example. The light recombination element 106 performs a light-path combination mechanism by receiving light coming from one of the waveguides 103 and 104 or both (wherein light may exist in either one of these waveguides or in both of them), and producing an output light signal emerging from the device 100 at the device output channel 107.

The input signal may be composed of a multiple optical channel of light, either propagating in a fiber or being a collimated beam propagating in free space. The variable coupler 102 is of the kind receiving input light and distributing the received light energy between the two light-paths 103 and 104 in a predetermined manner.

In the present example of FIG. 1, the variable coupler 102 is a 1×2 continuously variable switch operable to selectively direct input light to either one of the two paths 103 and 104. Such a variable coupler mechanism can be realized using known approaches, such as Mach Zender Interferometers (MZI), variable Y junctions, variable mode converters, variable polarization rotator devices and a polarization splitter, switches, etc. In all the cases, the variable coupler 102 is realized as a continuously variable all optical switch. Hence, with the power at both output arms of the variable coupler being constant (defined by the input power), the power ratio between the arms, and consequently between the light-paths 103 and 104, is arbitrary and can be externally controlled. The optical functional element 105 is operable to affect an input signal to thereby provide output in accordance with a specific application of the device 100. The recombination element 106 is a second (output) variable coupler having two inputs and one or two output ports, and operated synchronously and in conjunction with the first (input) variable coupler 102 to recombine light input from both input channels 103 and 104 to produce the output 107 of the device.

The variable couplers 102 and 106, and the element 105 are associated with control units 108 and 109, respectively. Generally, the same control unit can operate all these elements. The control unit 108 operates the input variable coupler 102 to selectively provide propagation of the input light either through the waveguide 103 to thereby prevent light passage through the functional element 105, or through the waveguide 104 to thereby enable the entire input light passage through the element 105, and operates the output variable coupler 106 accordingly. The control unit 109 affects the operational condition of the functional element 105 (tuning).

In order to allow continuous flow of light through the device 100 (without disturbance of light flow during the adjustment (tuning) of the functional element 105), the entire input light signal is to be switched to the optical path 103 during the adjustment of the functional element 105, and is to be directed to the optical path 104 after the adjustment is complete. By maintaining the phase relationship between the two waveguides 103 and 104, the two fractions (components) of the input light interact constructively, and the light at the output waveguide 107 is unaffected during the transition period. This phenomenon can be analyzed using standard matrix approach (Integrated Optics, Reinhard Marz, Artech House 1995. p.197-207):

$$( \begin{matrix}{b}_{1} \\ {b}_{2}\end{matrix} ) = [ \begin{matrix}{m}_{11} & {m}_{12} \\ {m}_{21} & {m}_{22}\end{matrix} ] ( \begin{matrix}{a}_{1} \\ {a}_{2}\end{matrix} ) \qquad ( 1 )$$

wherein the optical waveguides are divided into four sections (waveguides 101, 103, 104 and 107 in FIG. 1; b₁,b₂—the field at the output of a given section; and a₁, a₂—the field at the input of a given section. The matrix for a coupler is given by

$$( \begin{matrix}{b}_{1} \\ {b}_{2}\end{matrix} ) = [ \begin{matrix}i & j \sqrt{1 - {t}^{2}} \\ - j \sqrt{1 - {t}^{2}} & i\end{matrix} ] ( \begin{matrix}{a}_{1} \\ {a}_{2}\end{matrix} ) \qquad ( 2 )$$

wherein t is the amplitude transmission of the coupled waveguides. The matrix for a phase section is given by,

$$( \begin{matrix}{b}_{1} \\ {b}_{2}\end{matrix} ) = [ \begin{matrix}{e}^{j Φ} & 0 \\ 0 & 1\end{matrix} ] ( \begin{matrix}{a}_{1} \\ {a}_{2}\end{matrix} ) \qquad ( 3 )$$

A Mach Zhender Interferometer (MZI) is obtained by matrix multiplication of a 2 by 2 50% coupler with a phase shift and an additional 2 by 2 50% coupler.

$$( \begin{matrix}{b}_{1} \\ {b}_{2}\end{matrix} ) = \frac{1}{\sqrt{2}} [ \begin{matrix}1 & 1 \\ 0 & 0\end{matrix} ] [ \begin{matrix}{e}^{j Φ} & 0 \\ 0 & 1\end{matrix} ] \frac{1}{\sqrt{2}} [ \begin{matrix}1 & 0 \\ 0 & 0\end{matrix} ] ( \begin{matrix}{a}_{1} \\ {a}_{2}\end{matrix} ) \qquad ( 4 )$$

if α₂ is equal to zero, i.e. there is only one input waveguide at the coupler, then the output power is divided between the output waveguides by the following tangential relationship,

$$( \begin{matrix}{b}_{1} \\ {b}_{2}\end{matrix} ) = \frac{1}{\sqrt{2}} [ \begin{matrix}- sin ( Φ ) + i cos ( Φ ) \\ sin ( - Φ ) - i cos ( Φ )\end{matrix} ] \qquad ( 5 )$$

The converse holds from reciprocity, hence any input conforming to such a power distribution can be manipulated by applying a MZI with the same phase difference, to provide an output in a single waveguide. Hence a combination of such MZI can route the optical signal through any of the combining waveguides, with no affect on the output energy.

Thus, in one operational mode of the device 100, the input variable coupler 102 directs the entire input light energy through the waveguide 104, where the optical element 105 (e.g., filter) is located. The optical element 105 then operates on the traffic carrying light. Light exiting from the optical element 105, enters the recombination element 106, which in this mode is transparent to light, and directs it to exit the device 100 through the output waveguide 107. In the other operational mode of the device 100, the variable coupler 102 is operated to direct the entire input light energy through the waveguide (light-path) 103, and therefore no light passes through the optical element 105. The light from the light-path 103 enters the recombination element 106 (which is again transparent and is operated by the control unit 108 accordingly), and leaves the device 100 through the output waveguide 107.

It is important to note that the operation of the output coupler 106 is critical to successful routing of light. Due to the reciprocal nature of light, the output coupler 106 has to be attuned to the spatial waveguide holding the light to successfully direct it to the output light path. To achieve this, the control unit 108 operates the input variable coupler 102 in accordance with the required light propagation through one of the waveguides 103 and 104, and then operates the output variable coupler 106 accordingly to ensure it is attuned to the respective one of the waveguides 103 and 104. Thus, the present invention provides for a mechanism of switching light from one waveguide to the other waveguide without causing a disturbance in the traffic (except for the action of the functional optical element), thereby creating a hitless tunable optical bypass switch.

The functional optical element 105 may be one of the following: a filter, gain element; a variable optical attenuator; a dispersive element; an interleave filter; an equalization filter, etc. The operational principles of all these elements are known per se and therefore need not be specifically described except to note the following. A filter device may be designed to perform the channel dropping function to redirect one of the channels of a WDM light source from the main waveguide to a local receiver. A gain element affects the light passing therethrough to increase the power of light, while a variable optical attenuator increases or reduces the power of light passing therethrough. A dispersive element typically changes the shape of a light signal passing therethrough. An interleave filter provides dropping of some channels of the input light. An equalization filter equalizes the energies of light in all the channels (e.g., different wavelength components of input light).

Thus, considering for example a channel dropping filter as the functional element 105 for filter out a specific wavelength component from the multiple-wavelength input light and allowing the other wavelength component to be output in the light path 107, the device 100 operates in the following manner. The functional element 105 is tuned (adjusted) to filter out the specific wavelength component λ₁ to an output channel (not shown) of the functional element 105 while allowing all other wavelength components propagation through the path 104. The input light 101 continuously flows through the waveguide 104, loaded with the functional element 105. When the functional element has to be returned to filter out a different wavelength component λ₂, the variable coupler 102 is operated to direct the input light 101 through the waveguide 103 thereby not disturbing the continuous flow of light through the device 100. When the tuning procedure is complete, the control unit 109 generates a signal to the control unit 108, and the latter operates the variable coupler 102 to return to its previous operational mode in which it directs the input light through the waveguide 104.

Preferably, the tunable device 100 is realized in the planar lightwave circuits (PLC) technique that has an inherent advantage in integration of complex optical functions. Light-paths are preferably realized using waveguides in which the refractive index of a core region, where light is guided, is higher than the refractive index of a cladding region. Light is typically introduced into the tunable device by coupling an optical fiber to the input waveguide of the device.

Reference is made to FIG. 2 illustrating an optical device 200 according to another example of the invention. To facilitate understanding, the same reference numbers are used for identifying those components which are common in the devices 100 and 200. The device 200 comprises a polarizing assembly composed of a polarization splitting element 201 accommodated upstream of the variable coupler 102 (with respect to the direction of propagation of the input signal 101), and a polarization rotation unit 204 (e.g., a half-wave plate). In this case, the variable coupler 102 has two inputs associated with two output waveguides 202 and 203 of the polarization splitting element 201, and has two outputs associated with the optical paths (waveguides) 103 and 104. Further provided in the device 200 is a polarization rotation unit 205 accommodated in the optical path 103. The provision of the polarization rotation units 204 and 205 is associated with the fact that in integrated optics it is often simpler to operate with one linear polarization.

The device 200 operates in the following manner. The input light signal received at the input channel of the device 101 impinges onto the polarization splitting element 201, which splits the input light into two components L⁽¹⁾ᵢₙ and L⁽²⁾ᵢₙ of different polarization directions and directs them to the light-paths 202 and 203, respectively. The light component L⁽¹⁾ᵢₙ passes the element 204, which rotates its polarization into the orthogonal one, i.e., that of the light component L⁽²⁾ᵢₙ, and thus the light components of the same polarization direction propagate through the waveguides 202 and 203, respectively, to input the variable coupler 102.

The variable coupler 102 now has a more complex role, since it has two inputs with different optical power, and two outputs. Such a variable coupler 102 may be a cascaded Mach-Zender Interferometer (MZI), wherein in chain interference is produced between phase coherent light waves that have traveled over different path lengths. The construction and operation of MZI are known per se and therefore need not be specifically described except to note that MZI utilizes the application of an external field, such as voltage, current or heat, to locally change the refractive index of the waveguide medium and thereby induce a phase change of the light traveling in the respective waveguide. Application of the specific mechanism is achieved by providing electrodes at the two channels in the vicinity of each waveguide. The phase change effect is equal to varying the effective path lengths of the channels, and the path difference creates an interference effect and thereby achieves switching between the two channels. Using the matrix method shows that cascaded MZI can transfer any combination of power in the two input waveguides (202 and 203) to any combination of power at the output waveguides (103 and 104).

In this embodiment, the recombination element 106 can advantageously be a static device (a passive polarization combiner) that does not need to be operated to follow the operation of the input variable coupler 102, as in the example of FIG. 1. The polarization of light traveling in either one of the waveguides 103 and 104 (the waveguide 103 in the present example) is rotated by the element 205 to the orthogonal polarization, and the recombination element 106 combines the two light components L⁽¹⁾ᵢₙ and L⁽²⁾ᵢₙ into an output unpolarized beam 107. In this example, during the switching transition stage, the polarization of one output light component changes (by means of element 205). However, optical networks are impervious to the state of polarization, and hence, this has no effect on the traffic flow.

The functional optical element 105 may be a closed loop compound resonator for storing optical energy of a predetermined frequency range. Such a closed loop compound resonator is disclosed in the above-indicated publication WO 01/27692 assigned to the assignee of the present application.

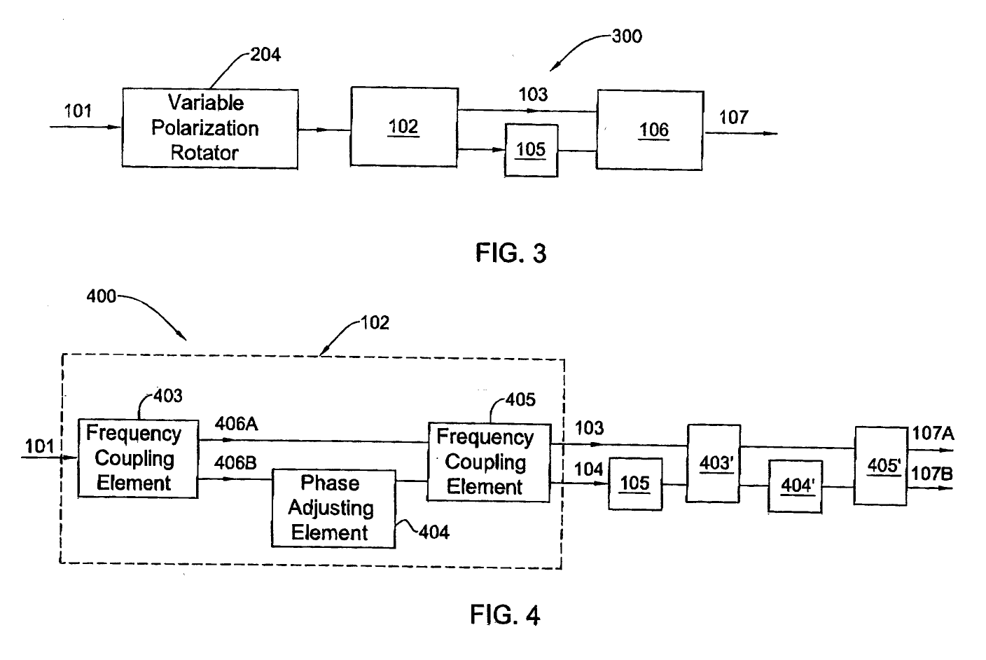

FIG. 3 illustrates an optical device 300 according to yet another embodiment of the invention. Similarly, the same reference numbers identify the system components that are common for all the examples. Here, a polarizing assembly includes a variable polarization rotator 204 located in the path of the input signal 101, and the variable coupler 102 and recombination element 106 are polarization splitter/combiner elements. The polarization rotator 204 is operable to change the polarization of input light 101, and therefore enable the variable coupler 102 to direct the input light either to the waveguide 103 or to the waveguide 104, depending on the polarization of light entering the variable coupler. This embodiment can be realized in an integrated waveguide device, as well as in an optical micro bench approach. In the latter, the polarization rotator 204 can be realized using a liquid crystal device, and the polarization splitters 102 and 106 can be standard Birefringent crystal (calcite).

Reference is now made to FIG. 4 illustrating yet another embodiments of the invention. An optical device 400 distinguishes from the previously described examples in that its input coupler structure 102, as well as output coupler structure 106, is designed as a tunable frequency selective filter structure utilizing adjustment of the phase of light passing therethrough. The coupler structure 102 (and 106) is composed of a first tunable frequency-coupling element 403 (element 403′ in the structure 106), a phase adjusting element 404 (404′ in the structure 106), and a second tunable frequency-coupling element 405 (405′ in the structure 106). The element 403 has two input waveguides of which one is active as an input port for receiving multi-frequency input light 101 (either free propagating or from an input waveguide), and has two outputs associated with two spatially separated optical channels (waveguides) 406A and 406B. The phase adjusting element 404 is placed in one of the channels 406A and 406B—channel 406B in the present example. The element 405 (which is a reciprocal of the element 403) has two inputs associated with the waveguides 406A and 406B, and two outputs associated with two spatially separated light paths (waveguides) 103 and 104. One of the light paths 103 and 104 (light path 104 in the present example) is loaded with an optical functional element 105, which is of the kind affecting light of a specific frequency band. Each of the coupler elements 403 and 405 is operable to transfer at least a portion of power of the selected frequency band of the input light to the channel 406B while allowing propagation of the remaining portion of the input light (i.e., remaining portion of the selected frequency band and all other frequency bands of the input light) through he channel 406A. The coupler structure 106 (recombination element) is constructed

[symbol]

Each of the frequency coupling elements (403, 403′ and 405, 405′) can be realized using a GAC [“Grating-Assisted Codirectional Coupler Filter Using Electrooptic and Passive Polymer Waveguides”, Seh-Won, Ahn and Sang-Yung Shin, IEEE Journal on Selected Topics in Quantum Electronics, Vol. 7, No. 5, September/October 2001, pp. 819-825] known as transferring light of a specific frequency band from one output channel to the other.

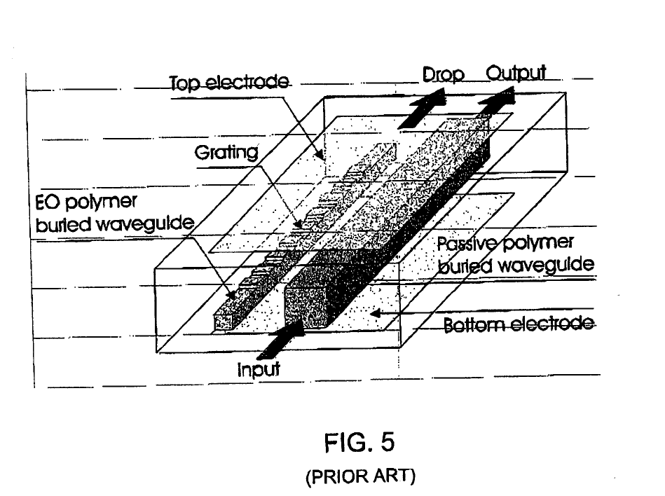

A shown in FIG. 5, such a GAC device (“band-rejection filter”) has buried polymer waveguides, one being the passive polymer waveguide used for the input and the output ports, and the other being the electrooptical (EO) polymer waveguide used as a drop port. Power coupling is achieved by using the diffraction grating etched on top of the EO polymer waveguide. Maximal coupling occurs at a wavelength λ₀ that satisfies the phase-match condition |N₂-N₁|=λ₀/Λ, wherein N₂ and N₁ are the effective indexes of the two respective waveguide modes and Λ is the grating period. Satisfaction of the phase-match condition enables strong coupling when the lightwave from one waveguide adds in-phase to the other waveguide and weak coupling when it adds out-of-phase. Therefore, the optical power can flow substantially to the other waveguide. The optical input launched into the passive polymer waveguide is coupled to the EO polymer waveguide at the wavelength λ₀, whereas it just passes through the passive polymer waveguide at other wavelengths.

It should, however, be understood that a coupling element of any other suitable kind can be used as well, for example the coupling elements whose physical parameters, such as the length of the coupler, the strength of coupling between the waveguides, and the phase difference across the coupling length, define the amount of transferred energy.

Turning back to FIG. 4, the first frequency-coupling element 403 directs at least a part L⁽¹⁾₁ of a selected frequency band F₁ of the input light 101 to one of the channels 406A and 406B, while directing light L₂ of the other frequency band F₂ of the input light and a remaining part L⁽²⁾₁ of the selected frequency band F₁ (in the case of incomplete transfer of light of the selected frequency band) to the other channel. The power ratio (L⁽²⁾₁/L⁽¹⁾₁) of the selected frequency band F₁ in the channels 406A and 406B depends on the selected wavelength and the GAC parameters. In the present example, the frequency-coupling element 403 operates to transfer half of the power of the specific frequency band F₁ to the waveguide 406B. The input light portion L₂ outside the selected (coupling) frequency band exists in one of the waveguides 406A and 406B only (waveguide 406A in the present example), and the power of light within the coupling frequency band F₁ is equally distributed between the waveguides 406A and 406B: L⁽²⁾₁ in waveguide 406A and L⁽¹⁾₁ in waveguide 406B.

The phase adjusting element 404 is placed on the waveguide 406B and is selectively operated by a control unit (not shown) to affect the phase of light propagating therethrough to enable a continuously adjustable phase delay up to 180° between the channels 406A and 406B. The optical phase may be changed by applying an electric field and using the electroptic effect; by using a resistive heater and the thermo-optic effect, by current injection in a semiconductor material, as well as piezo or other mechanical effects.

At the reciprocal frequency-coupling element 405, the relative phase between the two input arms (channels 406A and 406B) defines the energy buildup in the coupler. As for the first coupler 403, here only a selected band of frequencies interacts across the coupler length. Hence, the unselected frequencies, which are coming across only the first waveguide 406A, pass through the coupler to the output waveguide, which constitutes the express output. The selected frequency band arrives at both input ports of the coupler 405 with a relative phase difference. Since the coupler is a linear optical element, each input can be treated separately. If the coupler 405 acts similar to the couple 403 to couple half of the input light to each of the output waveguides 103 and 104, then in each of the output channels the light from each of the inputs will be equal in amplitude. If the phase difference is zero, constructive interference will cause the light of the selected frequency band to be located in the light path 104, and not in the light path 103. If the phase difference is 180°, then destructive interference will cause the selected frequency band to be located in the light path 103 and not in the drop path 104.

Thus, in one operational mode of the device 400, the phase adjusting element 404 is operated to appropriately affect the phase of light passing therethrough. The light L₂ of a frequency band other than the coupling frequency band is unaffected by any phase changes (since this light exists in the waveguide 406A only), while that half of light of the coupling frequency band L⁽¹⁾₁ which propagates through the waveguide 406B undergoes phase changes. In this operational mode, light L⁽¹⁾₁ coming from the waveguide 406B is out-of-phase, and the element 405 transfers this light to the light path 103. Hence, the entire input light propagates through the waveguide 103 to pass through the output coupler structure (recombining element) 106, and no light exists in the light path 104, the dropping/adding function of the device 100 (carried out by the element 105) being therefore inoperative in this operational mode of the device 400. The output coupler structure 106 operates in conjunction with the input structure 102 to allow the entire input energy propagation through one of the two outputs of the device 400—output 107A in the present example.

In the other operational mode of the device 400, when the dropping/adding function of the device is to be performed, the element 404 is in its inoperative position, not affecting the phase of light passing therethrough. As a result, light L⁽¹⁾₁ coming from the waveguide 406B is in-phase with light of the selected frequency band L⁽¹⁾₁ in the waveguide 406A, and the element 405 transfers the light portion L⁽²⁾₁ of the coupling frequency band to the waveguide 104. Hence, the entire light of the coupling frequency band F₁ passes through the waveguide 104 (spatially separated from all other frequency components of the input light passing through the light path 103) and enters the functional element 105. The latter affects this selected frequency band (e.g., selects therefrom a specific frequency component, performs attenuation, etc.). The, the output frequency-selective coupler 106 recombines light coming from the paths 103 and 104 and produces one or two output components.

Those skilled in the art will readily appreciate various modifications and changes can be applied to the embodiments of the invention as hereinbefore exemplified without departing from its scope defined in and by the appended claims.

1. A method for controlling continuous propagation of input light through an optical device having an optical functional element of a controllably adjustable operation to affect light passing therethrough, the method comprising:
(i) distributing in a predetermined manner the input light energy between first and second spatially separated paths, said optical functional element being accommodated in the first path;
(ii) recombining the first and second paths downstream of the optical functional element with respect to a direction of light propagation through the device, to produce a light output of the optical device,
thereby allowing for directing substantially the entire energy of the input light through the second path, during adjustment of the operation of the functional optical element, and redirecting at least a predetermined portion of the input light to the first path to pass through the functional element, upon completion of the adjustment.

2. The method according to claim 1, wherein the distribution of the input light energy comprises applying a multiple channel coupling mechanism to the input light.

3. The method according to claim 2, wherein said multiple channel coupling mechanism comprises selectively directing the entire input light energy to either one of the first and second paths.

4. The method according to claim 3, wherein said distribution of the input light energy comprises passing the input light through a variable coupler structure.

5. The method according to claim 4, wherein said variable coupler structure includes one of the following: Mach Zender Interferometer (MZI), variable Y junction, mode converter, variable polarization rotator device and a polarization splitter, and switch.

6. The method according to claim 1, wherein the distribution of the input light energy comprises applying a frequency selective coupling mechanism to the input light, said predetermined portion of the input light being a selective frequency band of the multi-frequency input light.

7. The method according to claim 6, wherein said frequency select coupling mechanism comprises:
applying variable frequency-selective coupling to the multi-frequency input light to thereby split it into first and second light components propagating through two spatially separated channels, respectively, the first light component comprising at least a portion of power of the selected frequency band of the input light, and the second light component comprising a remaining portion of the selected frequency band and all other frequency bands of the input light;
selectively creating a phase delay between the two channels by adjusting the phase of said first light component;
depending on the phase of said first light component, either combining the first and second light components to propagate through said second path with substantially no power in the first path where the functional element is located, or directing all the power of the selected frequency band through the first path while directing all other frequency components of the input light through the second path.

8. The method according to claim 7, wherein the distribution of the input light energy comprises passing the input light through a variable coupler structure.

9. The method according to claim 8, wherein said variable coupler structure includes a grating assisted coupler or a ring-like resonator structure.

10. The method according to claim 1, wherein said recombining of the first and second paths is carried out in conjunction with said distribution of the input light energy, such that the same percentage of the input light energy redirected into each of the first and second paths during the input light energy distribution, is recombined.

11. The method according to claim 10, wherein said recombining comprises applying a multiple channel coupling mechanism to the light coming from said first and second paths.

12. The method according to claim 10, wherein said recombining comprises applying a frequency selective coupling mechanism to the light coming from said first and second paths.

13. The method according to claim 10, wherein said recombining comprises passing light from said first and second paths through a variable coupler structure.

14. The method according to claim 10, wherein said recombining comprises passing the light through a variable coupler structure including one of the following: Mach Zender Interferometer (MZI), variable Y junction, mode converter, variable polarization rotator device and a polarization splitter, switch, grating assisted coupler and ring-like resonator structure.

15. The method according to claim 1, comprising
prior to said distribution of the energy of the input light, splitting the input light into two spatially separated light components of different polarization directions, and applying a 90° polarization rotation to one of the split light components, thereby producing two spatially separated light components of the same polarization directions, and
prior to recombining the first and second paths, applying a 90° polarization rotation to the light component propagating through one of the optical paths.

16. The method according to claim 1, comprising applying a controllable polarization rotation to the input light prior to said distribution of the input light energy.

17. A method for hitless tuning of an optical device having an optical functional element of a controllable adjustable operation for affecting light passing therethrough, the method comprising:
passing input light through an input variable coupler structure having an input port for receiving the input light and two output ports associated with first and second spatially separated paths, said functional elements being located in the first optical path;
recombining the first and second paths by an output variable coupler structure which is located downstream of the optical functional element with respect to a direction of light propagation through the device, and has two input ports associated with said first and second paths and an output port associated with an output channel of the optical device;
operating the input and output variable coupler structures to distribute the input light energy between the first and second paths, so as to allow for selectively directing substantially the entire energy of the input light through the second path, during adjustment of the operation of the functional optical element, and redirecting at least a predetermined portion of the input light to the first path to pass through the functional element, upon completion of the adjustment.

18. A method for hitless tuning of an optical device having an optical functional element of a controllable adjustable operation for affecting light passing therethrough, the method comprising:
passing input light through a polarizing assembly thereby producing at least one light component of a predetermined polarization direction;
passing the light of the predetermined polarization direction through an input variable coupler having an input port for receiving the input light and two output ports associated with first and second spatially separated paths, said functional elements being located in the first optical path
recombining the second optical path and the fist optical path downstream of the optical functional element with respect to a direction of light propagation through the device, to thereby produce output of the optical device propagating through an output channel,
thereby allowing for selectively directing substantially the entire energy of the input light through the second optical path, the adjustment of the operation of the functional optical element, and redirecting at least a predetermined portion of the input light to the first optical path to be affected by the functional element, upon completion of the adjustment.

19. The method according to claim 18, wherein
said passing of the input light through the polarizing assembly comprises splitting the input light into two spatially separated light components of different polarization directions, and applying a 90° polarization rotation to one of the split light components, thereby producing two spatially separated light components of the same polarization directions inputting the input variable coupler; and
prior to combining the first and second optical paths, a 90° polarization rotation is applied to the light component propagating through one of the first and second paths.

20. The method according to claim 18, wherein said passing of the input light through the polarizing assembly comprises controllably rotating the polarization of the input light.

21. A method for hitless tuning of an optical device having an optical functional element of a controllable adjustable operation for affecting light passing therethrough, the method comprising:
applying frequency selective variable coupling to multi-frequency input light to thereby produce first and second light components propagating through two spatially separated channels, respectively, the first light component comprising at least a portion of power of a selected frequency band of the input light, and the second light component comprising a remaining portion of the selected frequency band and all other frequency bands of the input light;
selectively creating a phase delay between the two channels by adjusting the phase of said first light component;
depending on the phase of said first light component, either directing all the power of the selected frequency band through a first path where the functional element is located while directing all other frequency components of the input light through a second path spatially separated from the first path, or combining the first and second light components to propagate through the second path with substantially no power in the first path; and
combining the first and second paths by an output variable frequency selective coupler structure, which is located downstream of the optical functional element with respect to a direction of light propagation through the device, and has two input ports associated with said first and second paths and an output port associated with an output of the optical device;
thereby allowing for selectively directing substantially the entire energy of the input light through the second optical path, during the adjustment of the operation of the functional optical element, and selectively redirecting the selected frequency band to the first path while allowing propagation of all other frequencies of the input light through the second path, upon completion of the adjustment.

22. An optical device comprising:
(a) an input variable coupler structure operable to receive input light and distribute in a predetermined manner the input light energy between first and second spatially separated paths;
(b) an optical functional element accommodated in the first path, said functional element being of a controllable adjustable operation to affect light passing therethrough;
(c) a recombination element accommodated in said first and second paths downstream of the optical functional element with respect to a direction of light propagation through the device, said recombination element operating to produce light output of the device from light coming from at least one of said first and second paths.

23. The device according to claim 22, wherein the input variable coupler structure is operable to perform a multiple channel coupling mechanism.

24. The device according to claim 23, wherein the input variable coupler structure is operable to receive the input light and selectively direct the entire input light energy to either one of the first and second paths.

25. The device according to claim 24, wherein the input variable coupler structure comprises one of the following: Mach Zender Interferometers (MZI), variable Y junction, mode converter, variable polarization rotator device and a polarization splitter, and switch.

26. The device according to claim 22, wherein the input variable coupler structure is operable to perform a frequency selective coupling mechanism.

27. The device according to claim 26, wherein
the input variable coupler structure comprises a first frequency coupling element having an input port and two output ports associated with two spatially separated channels, respectively; a phase adjusting element accommodated in one of the two channels; and a second frequency coupling element having two input ports associated with said two channels, respectively, and two output ports associated with said first and second paths, respectively;
the first frequency coupling element is operable to split the multi-frequency input light into first and second light components propagating through said two spatially separated channels, respectively, the first light component comprising at least a portion of power of a selected frequency band of the input light, and the second light component comprising a remaining portion of the selected frequency band and all other frequency bands of the input light;
the phase adjusting element is operable to selectively adjust the phase of said first light component, thereby selectively creating a phase delay between the two channels;
the second frequency coupling element is operable so as to selectively, depending on the phase of said first light component, combine the first and second light components to propagate through said second path with substantially no power in the first path where the functional element is located, or direct all the power of the selected frequency band through the first path while directing all other frequency components of the input light through the second path.

28. The device according to claim 27, wherein the input variable coupler structure comprises a grating assisted coupler or a ring-like resonator structure.

29. The device according to claim 22, wherein the recombination element is an output variable coupler structure, which has two inputs associated with said first and second paths and output associated with output of the device.

30. The device according to claim 22, wherein the recombination element is an output variable coupler structure operable to apply a frequency selective coupling mechanism to the light coming from the first and second paths.

31. The device according to claim 22, comprising a polarizing assembly accommodated in a path of the input light upstream of the input variable coupler structure.

32. The device, according to claim 31, wherein said polarizing assembly comprises a polarization splitter element that splits the input light into two spatially separated light components of different polarization directions, a first polarization rotator accommodated in a path of one of said split light components propagating towards the input variable coupler, and a second polarization rotator accommodated so as to apply polarization rotation to one of light components prior to inputting the recombination element.

33. The device according to claim 31, wherein said polarizing assembly comprises a controllable polarization rotator.

34. An optical device comprising:
an input variable coupler structure having an input port for receiving input light and two output ports associated with first and second spatially separated paths;
an optical functional elements located in the first optical path and operable in a controllably adjustable manner to affect light passing therethrough;
an output variable coupler structure located downstream of the optical functional element with respect to a direction of light propagation through the device, the output variable coupler structure having two input ports associated with said first and second paths and output associated with output of the optical device;
a control unit having means for adjusting the operation of the functional element, and means for operating the input and output variable coupler structures, to thereby enable distibution of the input light energy between the first and second paths to allow for selectively directing substantially the entire energy of the input light through the second path, during adjustment of the operation of the functional optical element, and redirecting at least a predetermined portion of the input light to the first path to pass through the functional element, upon completion of the adjustment.

35. An optical device comprising:
a polarizing assembly operable to receive input light and produce at least one light component of a predetermined polarization direction;
an input variable coupler having an input port for receiving said at least one light component of the input light, and two output ports associated with first and second spatially separated paths;
an optical functional elements located in the first optical path and operable in a controllable adjustable manner for affecting light passing therethrough;
a recombination element located in the first and second paths downstream of the optical functional element with respect to a direction of light propagation through the device, to thereby produce output of the optical device propagating through an output channel;
a control unit operating the input variable coupler structure and the recombination element for selectively directing substantially the entire energy of the input light through the second optical path, during the adjustment of the operation of the functional optical element, and redirecting at least a predetermined portion of the input light to the first optical path to be affected by the functional element, upon completion of the adjustment.

36. An optical device comprising:
an input frequency selective variable coupler structure comprising a first coupling element operable to apply a frequency selective coupling mechanism to multi-frequency input light to thereby produce first and second light components propagating through two spatially separated channels, respectively, the first light component comprising at least a portion of power of a selected frequency band of the input light, and the second light component comprising a remaining portion of the selected frequency band and all other frequency bands of the input light; a phase adjusting element located in the first optical channel and operable to selectively create a phase delay between the two channels by adjusting the phase of said first light component; and a second coupling element operable to, depending on the phase of said first light component, either direct all the power of the selected frequency band through a fist path while directing all other frequency components of the input light through a second path spatially separated from the first path, or combining the first and second light components to propagate through the second path with substantially no power in the first path;
an optical functional element located in said first path and operable in a controllable adjustable manner for affecting light passing therethrough, and
an output frequency selective variable coupler structure operable in conjunction with said input variable coupler structure, such that the same percentage of the input light energy redirected by the input coupler structure into each of the first and second paths is recombined by the output coupler structure.
